(19) United States
(12) Patent Application Publication
(10) Pub. No.: US 2014/0172502 A1
(43) Pub. Date: Jun. 19, 2014

(54) CONSUMER WALKER REPORTS

(71) Applicant: TARGET BRANDS, INC., Minneapolis, MN (US)

(72) Inventors: Daniel Lee Ryks, Minneapolis, MN (US); Russ Michael Heilbrun, Minneapolis, MN (US)

(73) Assignee: TARGET BRANDS, INC., Minneapolis, MN (US)

(21) Appl. No.: 13/719,981

(22) Filed: Dec. 19, 2012

(51) Int. Cl. G06Q 30/02

(52) U.S. Cl. CPC G06Q 30/0202
USPC 705/7.31

(57) ABSTRACT

A computer system identifies merchandise that has high loyalty at a retailer. The computer system determines a repeatability value of an item in a product category in an inventory at a retailer, wherein the repeatability value indicates how frequently a customer purchases the item out of a plurality of items in the product category. The computer system also determines an exclusivity value of the item, wherein the exclusivity value indicates how frequently the customer purchases the item instead of an alternative item out of the plurality of items in the product category. The computer system further generates a report related to the inventory of the retailer that is at least partially based upon the repeatability value and the exclusivity value of the item.

### BACKGROUND

Retailers include entities that sell merchandise. For example, a retailer is a business that retails general merchandise to consumers. In another example, a retailer is a business that wholesales merchandise to other businesses.

Retailers stock many different versions of a product in a particular category. For example, the retailer stocks several options for an item, such as different sizes or brands of laundry detergent. It is a common challenge to know which options of an item in a category to continue to stock for purposes of maintaining or improving sales.

### SUMMARY

In general, a computer system can be employed by a retailer to predict whether an item should continue to be stocked in a retailer's inventory to maintain or improve sales. In one example, the computer system determines a repeatability value of an item in a product category in an inventory at a retailer, wherein the repeatability value indicates how frequently a customer purchases the item out of a plurality of items in the product category. The computer system also determines an exclusivity value of the item, wherein the exclusivity value indicates how frequently the customer purchases the item instead of an alternative item out of the plurality of items in the product category. The computer system generates a report related to the inventory of the retailer that is at least partially based upon the repeatability value and the exclusivity value of the item.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram that illustrates an example environment in which the techniques of this disclosure may be implemented.

FIG. 2 is a block diagram that illustrates an example configuration of a server device including an inventory management system communicatively coupled to one or more client devices, in accordance with techniques described herein.

FIG. 3 is a block diagram of an example configuration of a computer system in which the techniques of this disclosure are implemented.

FIG. 4 is a graph that illustrates where merchandise items fall in terms of unit sales index versus repeat index on a walker grid, in accordance with techniques described herein.

FIG. 5 is a screenshot that illustrates a walker grid of a walker report that indicates where merchandise items fall in terms of unit sales index versus repeat index, in accordance with techniques described herein.

FIG. 6 is a screenshot that lists potential walker items identified in a walker report, in accordance with techniques described herein.

FIG. 7 is a screenshot that lists potential drop items identified in a walker report, in accordance with techniques described herein.

FIG. 8 is a flowchart that illustrates an example method for generating a walker report, in accordance with techniques described herein.

In accordance with common practice, the various described features are not drawn to scale and are drawn to emphasize features relevant to the present application. Like reference characters denote like elements throughout the figures and text.

### DETAILED DESCRIPTION

As described below, a computer system identifies products in an inventory of a retail store that have a high rate of customer loyalty. As used herein, the term “customer” refers to any person or entity that, for example, enters a retail store or browses a retailer's website, regardless of whether the person or entity actually purchases an item. Thus, a person who visits a retail store but does not purchase an item is referred to as a customer. Customers who shop for items with a high rate of customer loyalty may specifically return to shop at the retailer because they want to purchase that item. Identifying such products and basing inventory decisions on this information would assist the retailer with preventing or reducing the risk of loss of potential customers and sales.

Inventory items can be grouped into specific product categories. Each product category has two or more different versions of available items. The various items differ in one or more of size, quantity, quality, brand, packaging, price, ingredients, season, or other parameters. For example, one category is “laundry detergent.” There likely are several available items in stock at a retail store in the laundry detergent category to provide customers with options. These items include different brands of laundry detergent, different sizes (e.g., 50 ounce (oz), 100 oz, etc.), different purposes or strengths (e.g., mild, extra strong, etc.), different ingredients (e.g., perfumed, not perfumed, dyes, etc.), different forms (e.g., powdered, liquid, etc.), for example.

It may not be possible or desirable for a retailer to stock many unique items in a category. For example, stocking many different items collectively takes up a lot of shelf space. Other considerations when determining the number of different items to stock include additional purchase ordering, a more complicated inventory, increased costs, and other concerns.

In most cases, some items in a category are sold less often or make less profit than other items in the product category. The retailer may be tempted to eliminate these low sales items from its inventory. However, some of these items could have high customer loyalty. For example, some retail customers purchase only a particular item in a category. If the retailer discontinues stocking the item, such a customer goes to a competing retailer to buy that particular item. As used herein, a customer who likely would not purchase a substitute item in the category is referred to as a “walker,” which is used to refer to a customer that will walk out of a retail store if they do not find a particular item to which they have a high degree of loyalty. In some cases, the walker will not even return to the retailer in the future if the particular item is no longer available. In those cases, the retailer loses sales for the category, and potentially loses sales that would have been made by the walker in other categories as well.

An example is provided for illustration. An item, a soap bar, has mediocre sales but it has very loyal customers. The retailer eliminates the soap bar from its inventory because it has had mediocre sales. With the item no longer in the assortment of available products in the product category, customers refuse to choose a different item in the product category and decide to go to a different retailer to purchase the soap bar. Now that some customers are making a trip elsewhere to buy the soap bar, the retailer is potentially losing a trip to the store or losing the customer entirely.

A walker report can be used to make a drop decision between two items. A walker item is an item with high loyalty. If the item is dropped from the inventory, customers will go elsewhere to find the product. It is not a substitutable item. In other words, customers will not substitute another item in the category for a walker item. A drop item is an item that is considered to be substitutable and has similar sales to a walker item. However, the item has low loyalty and if removed from the assortment, the customer would likely select another option in the assortment.

Techniques of the disclosure measure customer behavior at a retailer over a time period to determine whether the customer repeatedly purchases particular items. The techniques enable the retailer to link shopping trips together in order to understand if quests are trying other items in a product category or are remaining exclusive to a particular item in the product category.

It may be desirable for the retailer to identify which items that, if dropped from the inventory, result in customers walking out of the retailer in order for the retailer to not lose those customers. Techniques of the present disclosure enable the retailer to identify customer loyalty to an item through measures of the repeatability and exclusivity of items. Repeatability of an item is a measure of how often a customer purchases the particular item. Exclusivity of an item is a measure of the particular item not being substitutable for another item in a category. Using repeatability and exclusivity, a retailer can make an informed decision regarding what items to stock. For example, the retailer continues to stock items that have high repeatability and exclusivity even if the items have relatively low sales volumes and/or profit margins.

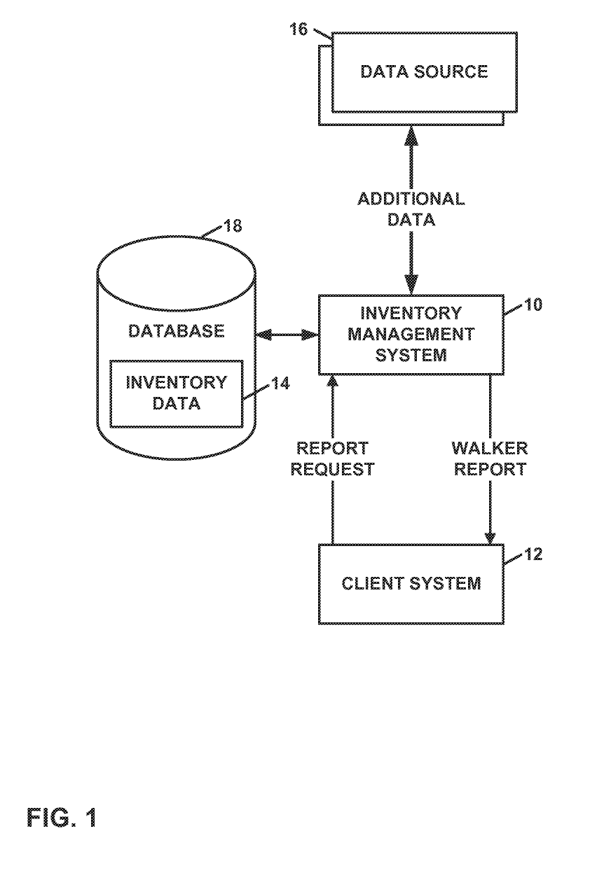

FIG. 1 is a block diagram that illustrates an example environment in which techniques of this disclosure may be implemented. As illustrated in the example of FIG. 1, the environment includes an inventory management system 10, a client system 12, a plurality of data sources 16, and a database 18. In other examples, the environment can include more, fewer, or different systems or components.

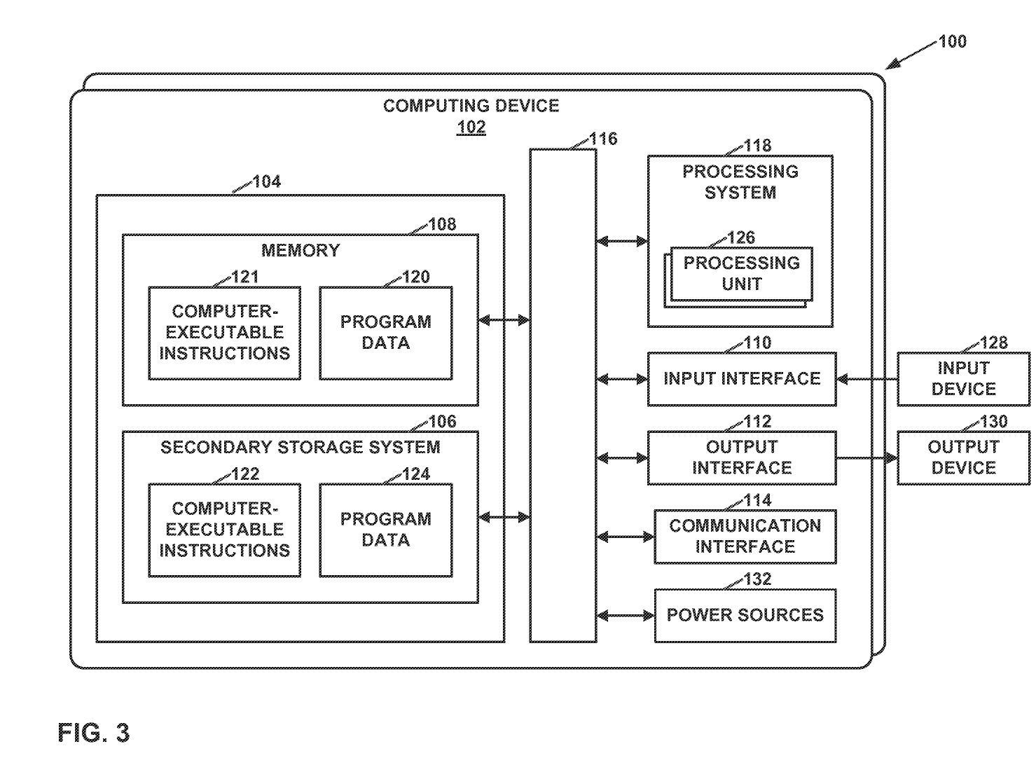

Inventory management system 10 and client system 12 may be implemented in various ways. In one example, inventory management system 10 and client system 12 is implemented as one or more software systems executed by one or more computing devices. FIG. 3, described in detail below, illustrates an example computer system that executes a software system to implement inventory management system 10, client system 12, data sources 16, and/or database 18. Example types of computing devices include personal computers, laptop computers, mainframe computers, tablet computers, server computers, smartphones, workstation computers, and other types of electronic computing devices. In other examples, inventory management system 10, client system 12, data sources 16, and/or database 18 are implemented as least in part using computing devices that have hardware specifically designed to implement inventory management system 10, client system 12, data sources 16, and/or database 18.

Database 18 may be implemented in various ways. In one example, database 18 is implemented as one or more relational databases, file systems, flat files, associative databases, object-oriented databases, or other types of data structures.

Inventory management system 10 is configured to communicate with client system 12, database 18, and data sources 16 in various ways. In one example, inventory management system 10 communicates with client system 12, database 18, and data sources 16 via one or more communication networks, such as local area networks (LANs), virtual private networks, or the Internet.

In some examples, a retailer is an entity that provides services or retails merchandise through physical, tangible, non-Internet-based retail stores or through Internet-based stores. In the case of a retailer that sells products and services through physical, tangible, non-Internet-based retail stores, each store of the retailer can include retail floor space including a number of aisles. Each of the aisles can have shelf and/or rack space for displaying merchandise. In some stores, at least some of the aisles have end caps for displaying additional merchandise. Each of the stores includes one or more checkout lanes with cash registers at which customers may purchase merchandise. In some examples, the checkout lanes are staffed with cashiers. In general, vendors include entities, such as other retailers or suppliers, from which the retailer receives merchandise or services, either directly or indirectly. As used herein, the term merchandise broadly refers to any tangible item or service that a retailer provides to a customer.

The data in inventory management system 10, database 18, and data source 16 can be updated on a recurring basis, independently or together. In one example, the data in inventory management system 10, database 18, or data source 16 is updated once per time interval. For instance, the data in inventory management system 10, database 18, or data source 16 is updated at least once per hour (e.g., once per fifteen minutes). In this example, the data in inventory management system 10, database 18, or data source 16 can be updated to reflect changes in inventories of one or more retail stores during the previous time interval. In some examples, the data in inventory management system 10, database 18, or data source 16 is updated whenever an item is added or removed from an inventory.

Inventory management system 10 manages and provides information about items that, if not stocked, may lead a customer to walk from the retailer. As used herein, “walk from a retailer” means that the customer does not shop at the retailer for any items in that product category for a least a given time period. For example, inventory management system 10 calculates an exclusivity value and repeatability value for particular items to determine if the items are walker items. As used herein, a “walker item” is an item that, if not stocked, one or more customers would not return to the retailer to shop in the product category of the walker item. That is, the customers will only purchase the walker item in the product category and will not purchase a substitute item in the category. If the walker item is not available at the retailer, the customers might go to a competitor of the retailer at the very least to purchase the walker item and possibly to purchase other items the customers used to purchase at the retailer.

The exclusivity and repeatability values may be calculated for only a subset of total customers who visit the retailer within a time period. For example, inventory management system 10 determines exclusivity and repeatability values for items purchased only by customers that can be identified who shopped at the retailer in a particular year. In some examples, purchases of a subset of the identifiable customers are used in the calculations for exclusivity and repeatability values, such as when calculating exclusivity and repeatability values for all customers would be prohibitive in terms of processing power or cost, or would not be necessary to identify a walker item.

Because exclusivity is a measure of whether a customer purchases only a specific item in a product category, customers whose shopping patterns are identifiable provide more reliable data than purchases by unidentified customers. Therefore, inventory management system 10 determines a measure of how often the customer purchases the particular item instead of another item in the product category. In one example, a higher exclusivity value for an item correlates with a greater likelihood that the customer purchases only that item in the product category.

Likewise, because repeatability is a measure of whether a customer returns to the retailer to purchase the same item again, customers whose shopping patterns are identified will provide more reliable data than purchases by unidentified customers. Therefore, inventory management system 10 determines a measure of how often the customer purchases the particular item. In one example, a higher repeatability value for an item indicates the customer returns to the retailer more frequently to purchase the item.

In some examples, inventory management system 10 determines an index value for the item. The index value indicates a likelihood that the item is a walker item. The index value is based at least in part on the exclusivity value and the repeatability value of the item. In one example, inventory management system 10 determines the index value for the item based on a number of total customers that have purchased the item multiplied by a ratio of a total amount of sales of all items in the product category over a time period and a total amount of sales of the item over the same time period.

Inventory management system 10 stores data in database 18 in some examples. Database 18 may be separate from or part of inventory management system 10. Data stored in database 18 can include information related to items or products analyzed by inventory management system 10. Information about each item in the list of items is included in database 18, including, but not limited to, information such as what product category or categories to which the item belongs, a size of the item (e.g., small, medium, large, super value size, etc.), a volume of the item (e.g., 50 ounce (oz), 100 oz, etc.), amount of the item (4 count (ct), 12 ct, 24 ct, etc.), and seasonality of the item (e.g., winter, first harvest, summer, etc.). Database 18 also includes information related to sales of particular items. For example, a number of units of the item sold over a time period is recorded in database 18.

In the example of FIG. 1, database 18 includes inventory data 14. In some examples, inventory data 14 includes information relating to what items are currently stocked at the retailer. In some examples, inventory data 14 also includes information relating to what items have been previously stocked at the retailer and/or what items are to be stocked in the future. Inventory data 14 can also include a list of items that are or have been in the inventory.

In some examples, database 18 includes data only for a particular store location of the retailer. In other examples, database 18 includes data for most or all stores within a geographical region. Further, database 18 can include data for all stores of the retailer. In other examples, other sets of data are included in database 18.

Inventory management system 10 also stores data in and obtains data from data sources 16. Data sources 16 may be separate from or part of inventory management system 10. Data stored in data sources 16 includes information related to items or products analyzed by inventory management system 10. In some examples, data source 16 includes information related to sales of particular items at other locations of the retail store.

Inventory management system 10 obtains data from data sources 16 in response to various events. For example, inventory management system 10 obtains data from one or more of data sources 16 in response to receiving a request for a report. Information available from data sources 16 includes tables that provide information about which merchandise is purchased by identifiable customers. The information provided by data sources 16 includes purchase orders, quantities, shipment dates, and other information about the process of customers purchasing merchandise from one or more stores of the retailer. Other information that can be included is information about recorded sales of particular items within a product category.

Within a product category, sales information for an item is recorded in database 18 or data source 16. The sales information includes which customer purchased the item, how many total number of the items were purchased, dates and times of sales, frequency of sales, purchase price, discounts applied to the item during sales, or other information. Inventory management system 10 uses this information to determine repeatability values and exclusivity values for merchandise of the retailer.

Inventory management system 10 obtains data from database 18 and/or data sources 16 in various ways. For example, inventory management system 10 issues a query, such as a SQL query, to database 18 or data sources 16. In another example, inventory management system 10 implements an application programming interface (API) containing one or more operations that can be invoked to obtain the data from database 18 or data sources 16. In another example, inventory management system 10 implements a web server that retrieves the data from database 18 or data sources 16 in response to web services requests, such as hypertext transfer protocol (HTTP) requests.

Client system 12 is a system that interacts directly with inventory management system 10. For example, client system 12 obtains information from and provides information to inventory management system 10. Furthermore, client system 12 provides an interface for representatives of the retailer to be able to exchange information regarding sales and to obtain information from inventory management system 10. In some examples, inventory management system 10 is a centralized computer system that any branch store of the retailer can access. For example, an inventory purchaser at a branch store of the retailer accesses client system 12 to request walker reports from inventory management system 10. In other examples, inventory management system 10 is a local system for a branch store or other facility of the retailer or another organization associated with the retailer, such as a vendor.

Inventory management system 10 receives report requests from client system 12. As used herein, any request from client system 12 for information from inventory management system 10 is referred to as a report request. In response to receiving a report request from client system 12, inventory management system 10 generates a report and outputs the report. In some examples, the report includes data identifying walker items. A report that includes information on repeatability and exclusivity of a merchandise item is referred to herein as a “walker report.” A walker report includes data for one or more items sold by a retailer. A walker report further includes information for one or more items in a single product category or contains information for items in two or more product categories.

A walker report contains information including one or more of repeatability and exclusivity of a merchandise item, identifying a product category of the item, a number of sales of the item in a given time period, an index value of the item, and a prediction of the likelihood that the item is a walker item. Walker reports can also include information such as what products are available in the product category for a particular store, what items are in stock in the store, and the like. In another example, the report indicates historical or statistical information associated with the item, such as past sales, how many options were available for customers in the product category, whether any customers did not return to the store if the item was not stocked, or the like.

After inventory management system 10 generates a walker report, inventory management system 10 outputs the walker report. Inventory management system 10 outputs the walker report in one or more various ways. For example, inventory management system 10 outputs the walker report by transmitting data representing the walker report to client system 12 via a communication network. In another example, inventory management system 10 writes data representing the report to a physical computer-readable storage medium, such as an optical disc, a floppy disk, a solid-state memory device (e.g., a thumb drive), and so on. In another example, inventory management system 10 outputs the walker report by printing the report to paper. In another example, inventory management system 10 outputs the walker report on a display screen.

The data representing the report includes data formatted in one or more various ways. For example, the data representing the report can include Hypertext Markup Language (HTML), extensible markup language (XML), a word processor document, a spreadsheet document, comma separated values (CSV) formatted data, portable document format (PDF), and/or data formatted in other ways.

Upon receiving the walker report from inventory management system 10, client system 12 presents the walker report to one or more users of client system 12. Client system 12 presents the walker report in various ways. For example, client system 12 displays the walker report in a web browser application. In another example, client device 12 displays the walker report in a special-purpose application, such as a spreadsheet application, a word processor application, a database access application, or another type of application.

In this way, a computer system that implements inventory management system 10 provides information to the retailer to use in defining an inventory. Inventory management system 10 identifies merchandise items that have low sales but high loyalty. Through determining repeatability values and exclusivity values for a merchandise item, inventory management system 10 predicts how likely an item is to be a walker item. Based on this information, the retailer decides whether to continue stocking the item in its inventory. Knowing which items are likely to be walker items enables the retailer to define its inventory to try to maintain or improve sales.

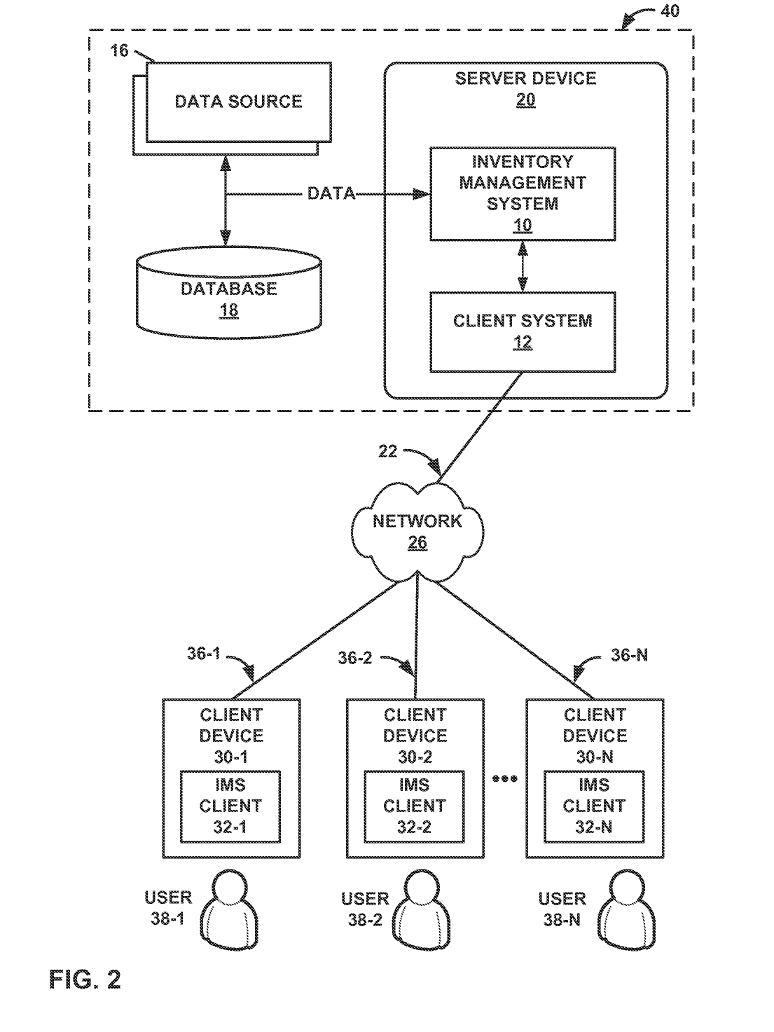

FIG. 2 is a block diagram that illustrates an example configuration of a server device 20 including inventory management system 10 communicatively coupled to two or more client devices 30-1 through 30-N. In this example, a retailer 40 maintains server device 20 and inventory management system 10. Client devices 30-1 through 30-N (referred to collectively as “client devices 30”) communicate with server device 20 via network 26. For purposes of describing the example of FIG. 2, branch stores of retailer 40 use one or more client devices 30 to communicate with server device 20. A retailer, for example, a headquarters of a chain retail store, uses server device 20 and maintain and control inventory management system 10. Various components described in FIG. 2 include similar properties and characteristics as described throughout this disclosure.

In the example of FIG. 2, server device 20 includes inventory management system 10 and client system 12, which function as described above with respect to FIG. 1. Server device 20 sends data to or retrieves data from one or more data sources 16 and database 18. As shown in FIG. 2, database 18 and data sources 16 are external to server device 20. However, in other examples, database 18 and data sources 16 are internal to server device 20. Inventory management system 10 manages database 18. For instance, inventory management system 10 stores data into database 18 and retrieves data from database 18 in response to queries received by inventory management system 10.

In other examples, server device 20 includes more, fewer, or different components. Server device 20, including the particular systems, components, and modules illustrated in the example of FIG. 2, can be implemented in software, hardware, or a combination of both software and hardware components. Various components of server device 20 are implemented in a single computing device or distributed across multiple computing devices collocated or communicatively connected between a number of locations.

Examples of client devices 30 include, but are not limited to, portable or mobile devices such as mobile phones (including smart phones), laptop computers, personal digital assistants (PDAs), desktop computers, or any other computing device. Client devices 30 may be the same or different types of devices. FIG. 2 illustrates an example with three client devices 30. However, any other natural number, N, of client devices 30 are present in other examples.

Each client device 30-1 through 30-N includes an inventory management system (IMS) client 32-1 through 32-N (collectively referred to as “IMS clients 32”), respectively. IMS clients 32 can be used to interface with inventory management system 10 of server device 20. For example, an IMS client 32-1 is an application executed by client device 30-1 that connects client device 30-1 to inventory management system 10, which includes a web browser. Interacting with IMS client 32-1 enables user 38-1 to create, manage, maintain, or otherwise interact with business partner relationships with other vendors. IMS client 32-1 is also used to store or retrieve data in database 18 or data sources 16.

As illustrated in FIG. 2, each client devices 30-1 through 30-N communicates with server device 20 through network 26 via at least one communication channel 36-1 through 36-N, respectively. Server device 30 communicates with network 26 via communication channel 22.

Users 38-1 through 38-N (collectively referred to as “users 38”) interact with client devices 30-1 through 30-N, respectively. Users 38 are members or representatives of retailer 40, such as employees, branch representatives, managers of inventory, or the like. In some examples, each user 38 is a representative of a different branch of retailer 40. Users 38 request walker reports from inventory management system 10. In some examples, users 38 provide information to inventory management system 10 regarding merchandise items, such as sales, list of items in stock, customer information, or other information used to generate walker reports. It is noted that although customers are identified by way of transaction data received by the retailer, the identities and personal information of the customers that shop at the retailer can be kept confidential. Inventory management client 32 enable user 38 to provide information about the branch store's inventory.

FIG. 3 is a block diagram of an example configuration of a computer system 100 in which the techniques of this disclosure may be implemented. In the example of FIG. 3, computer system 100 comprises a computing device 102 and one or more other computing devices. Computer system 100 or similar computing systems implement inventory management system 10, client system 12, database 18, and/or data sources 16. For example, computer system 100 is an example server device 20 of FIG. 2. In another example, computer system 100 implements inventory management system client 32. In such an example, computer system 100 is an example client device 30 of FIG. 2. FIG. 3 illustrates only one particular example of computer system 100, and many other example embodiments of computer system 100 are used in other instances.

Computing device 102 is an electronic device that processes information. In the example of FIG. 3, computing device 102 comprises a data storage system 104, a memory 108, a secondary storage system 106, a processing system 118, an input interface 110, an output interface 112, a communication interface 114, one or more power sources 132, and one or more communication media 116. Communication media 116 enable data communication between processing system 118, input interface 110, output interface 112, communication interface 114, memory 108, and secondary storage system 106. Computing device 102 can include components in addition to those shown in the example of FIG. 3. Furthermore, some computing devices do not include all of the components shown in the example of FIG. 3. Each of components 104, 106, 108, 110, 112, 114, 116, 118, 120, 121, 122, 124, 126, 128, 130, and 132 can be interconnected (physically, communicatively, or operatively) for inter-component communications.

Data storage system 104 is a system that stores data for subsequent retrieval. In the example of FIG. 3, data storage system 104 comprises memory 108 and secondary storage system 106. Memory 108 and secondary storage system 106 store data for later retrieval. In the example of FIG. 3, memory 108 stores computer-executable instructions 121 and program data 120. Secondary storage system 106 stores computer-executable instructions 122 and program data 124. Physically, memory 108 and secondary storage system 106 each comprise one or more computer-readable storage media.

A computer-readable medium is a medium from which a processing system can read data. Computer-readable media include computer storage media and communications media. Computer storage media can further include physical devices that store data for subsequent retrieval. Computer storage media are not transitory. For instance, computer storage media do not exclusively comprise propagated signals. Computer storage media include volatile storage media and non-volatile storage media. Example types of computer storage media include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media includes media over which one device can communicate data to another device. Example types of communication media include communication networks, communications cables, wireless communication links, communication buses, and other media over which one device is able to communicate data to another device.

Referring again to FIG. 3, processing system 108 is coupled to data storage system 104. Processing system 118 reads computer-executable instructions (e.g., 121, 122) from data storage system 104 and executes the computer-executable instructions. Execution of the computer-executable instructions by processing system 118 configures and/or causes computing device 102 to perform the actions indicated by the computer-executable instructions. For example, execution of the computer-executable instructions by processing system 108 can configure and/or cause computing device 102 to provide Basic Input/Output Systems (BIOS), operating systems, system programs, application programs, or can configure and/or cause computing device 102 to provide other functionality.

Processing system 118 reads the computer-executable instructions from one or more computer-readable media. For example, processing system 118 reads and executes computer-executable instructions 121 and 122 stored on memory 108 and secondary storage system 106.

Processing system 118 comprises one or more processing units 126. Processing units 126 comprise physical devices that execute computer-executable instructions. Processing system 118 can also include one or more operating systems that are executable by computing device 102. Processing units 126 comprise various types of physical devices that execute computer-executable instructions. For example, one or more of processing units 126 comprise a microprocessor, a processing core within a microprocessor, a digital signal processor, a graphics processing unit, or another type of physical device that executes computer-executable instructions.

Input interface 110 enables computing device 102 to receive input from an input device 128. Input device 128 comprises a device that receives input from a user. Input device 128 comprises one or more various types of devices that receive input from users. For example, input device 128 comprises a keyboard, a touch screen, a mouse, a microphone, a keypad, a joystick, a brain-computer interface device, or another type of device that receives input from a user. In some examples, input device 128 is integrated into a housing of computing device 102. In other examples, input device 128 is outside a housing of computing device 102. In some examples, input device 128 receives report requests, inventory data, and/or other types of data as described above.

Output interface 112 enables computing device 102 to output information on one or more output devices 130. One or more output devices 130, in some examples, are configured to provide output to a user using tactile, audio, or video output. For example, an output device 130 is a device that displays output. Example types of display devices include monitors, touch screens, display screens, televisions, and other types of devices that display output. In some examples, output device 130 is integrated into a housing of computing device 102. In other examples, output device 130 is outside a housing of computing device 102. In some examples, output device 130 displays walker reports or other types of data as described above. Output devices 130, in one example, includes a presence-sensitive screen or a touch screen. Output devices 130 can utilize a sound card, a video graphics adapter card, or any other type of device for converting a signal into an appropriate form understandable to humans or machines. Additional examples of output device 130 include a speaker, a cathode ray tube (CRT) monitor, a liquid crystal display (LCD), or any other type of device that can generate intelligible output to a user.

Communication interface 114 enables computing device 102 to send and receive data over one or more communication media. In some examples, computing device 102 utilizes one or more communication interfaces 114 to wirelessly communicate with an external device such as server device 20 or a client device 30 of FIG. 2, a mobile phone, or other networked computing device. Communication interface 114 comprises various types of devices. For example, communication interface 114 comprises a Network Interface Card (NIC), a wireless network adapter, a Universal Serial Bus (USB) port, or another type of device that enables computing device 102 to send and receive data over one or more communication media. In some examples, communications interface 114 comprises a network interface to communicate with external devices via one or more networks, such as one or more wireless networks. Examples of communications interface 114 are an Ethernet card, an optical transceiver, a radio frequency transceiver, or any other type of device that can send and receive information. Other examples of such network interfaces include Bluetooth®, 3G and Wi-Fi® radios in mobile computing devices. In some examples, communication interface 114 receives configuration data, trial data, and/or other types of data as described above. Furthermore, in some examples, communication interface 114 outputs information and/or other types of data as described above.

Computing device 102, in some examples, includes one or more power sources 132, which may be rechargeable and provide power to computing device 102. In some examples, the one or more power sources 132 are one or more batteries. The one or more batteries could be made from nickel-cadmium, lithium-ion, or any other suitable material. In another example, the one or more power sources 132 include a power supply connection that receives power from a power source external to computing device 102.

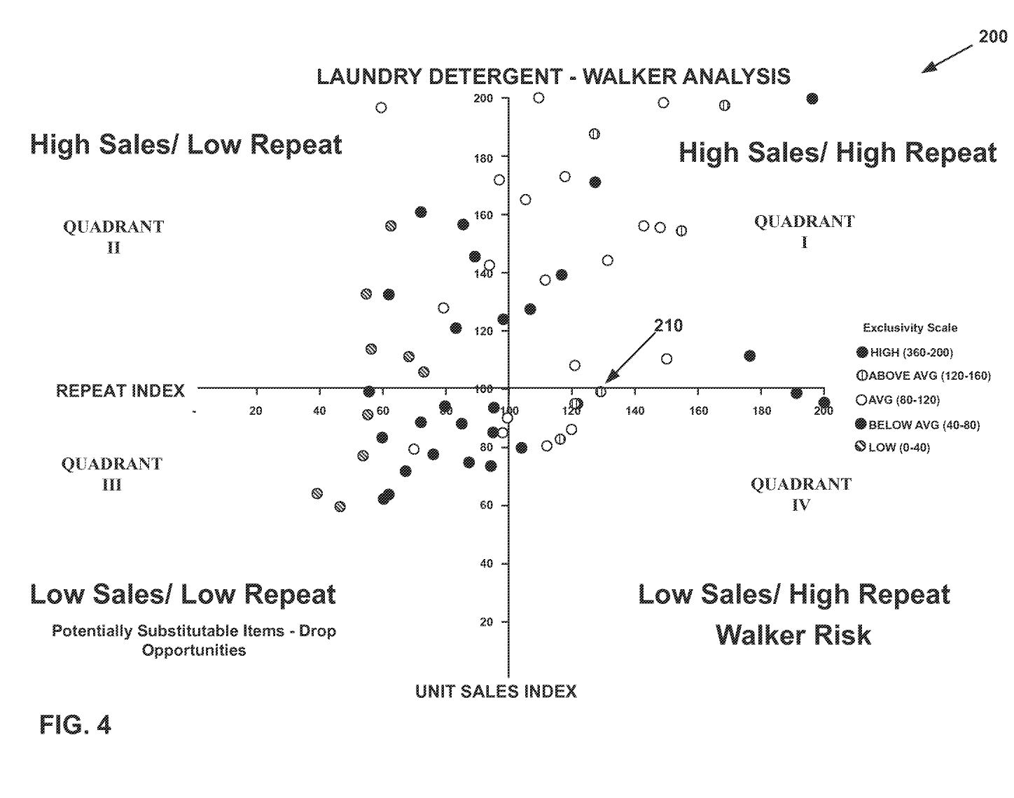

FIG. 4 is a graph that illustrates where merchandise items fall in terms of unit sales index versus repeat index on a walker grid 200. FIG. 4 illustrates an example of a walker report analysis of laundry detergent for a retailer in a given time period. The time period is a month, a season, or one or more years, for example. Walker grid 200 is generated by inventory management system 10 of FIGS. 1 and 2. Walker grid 200 represents data from one or more stores (for example, all stores or a specific geographic region) over a particular time period (for example, a season or a year).

A number of different laundry detergent products are represented in walker grid 200. The y-axis, labeled “unit sales index,” is a measure of how many units of the item are sold within a given time period. Unit sales measures item success. Within walker grid 200, a unit sale is an event that provides the retailer with a better understanding of item sales and provides better comparisons within the category. Actual unit sales of the laundry items are “indexed” in various ways, including, e.g., by dividing the actual unit sales of the item in one store by the average unit sales across all stores, by dividing the actual unit sales for one week in a month divided by the average unit sales for the whole month, or by dividing the actual unit sales of one laundry item in a category by the average unit sales of all items in the category.

The x-axis, labeled “repeat index,” is a measure of repeatability of the items. Each dot on walker grid 200 represents a unique product. In some examples, the repeat index measures customer loyalty to the item. In other examples, customer loyalty is a combination of repeatability and exclusivity.

In the example of FIG. 4, exclusivity is grouped in percentiles to provide a third measurement to walker grid 200 along with sales and repeat indices. The pattern, color, size of the dots (referred to herein as “items”), or some other property, indicate where the product falls on an exclusivity scale. The exclusivity scale represents how likely the customer is to purchase only that item in the category. In FIG. 4, the pattern of the dots indicates levels of exclusivity. As shown in walker grid 200, the exclusivity scale runs from low exclusivity (an index score of approximately 160-200) to high exclusivity (an index score of approximately 160-200). For example, the item represented by dot 210 has an above average exclusivity.

Walker grid 200 includes four quadrants, quadrant I through quadrant IV. Quadrant I includes items that have high sales and high repeatability. That is, those items sell more often and customers return to purchase the items more than items in the other quadrants. Most likely, a retailer would continue to stock items that fall into quadrant I. Quadrant II includes items that have high sales but low repeatability. Quadrant III includes items that have low sales and low repeatability. Not regarding exclusivity, if a retailer needed to eliminate items from its inventory, items that fall into quadrant III would probably be a good choice because not many customers are purchasing those items or making repeated purchases. Thus, not only are the items in quadrant III not producing good direct sales results, but they do not appear to engender a high degree of customer loyalty.

When evaluating lower sales items, repeatability and exclusivity can differentiate items that have similar sales. High repeatability indicates that customers who shop the item are loyal to it. High exclusivity indicates that customers are only coming to that category for that item alone. In some examples, exclusivity and repeatability are significant predictors of whether customers will leave the product category or the retail store if an item is removed.

Quadrant IV includes items that have low sales but high repeatability. Items that fall in quadrant IV, while they may not make as many sales as items in quadrants I or II, have customers who return to the retailer to purchase the item. When items in quadrant IV also have higher exclusivity (such as, for example, average exclusivity through high exclusivity), the item could be a walker item. For example, the item illustrated by dot 210 is a walker item. That is, the retailer will lose sales or visits from a customer who nearly solely purchase that item in the product category. Therefore, items in quadrant IV potentially have a walker risk. Thus, the walker report including walker grid 200 helps the retailer identify walker items, where the information is then be used to define an inventory at a retailer.

In the example of FIG. 4, walker grid 200 has a 26 week time period. In other examples, the time period is different due to considerations such as product type and frequency of purchase. In FIG. 4, sales were measured on a per store level due to the regionality of the items. In some examples, customer data from certain types of customers (such as employees of the retailer) are excluded due to potential skewing of the repeatability and exclusivity values.

Techniques of the disclosure leverage a model to predict a percentage of customers that leave the product category when an item is dropped based on item exclusivity and repeatability within the category. Each item represented in walker grid 200 is measured and indexed against all other items in the product category for all metrics over the time period. In some examples, the walker report uses a metric to combine repeatability and exclusivity values into an index value. In one example, a walker value for an item is calculated as shown in equation (1):

$$Walker Value = T * \frac{category spent}{customer} \qquad ( 1 )$$

wherein T is a total number of customers shopping the walker item. Category spent per customer measures how much money is spent in the category per customer. In some examples, it is assumed that an item brought in to replace a substitutable product will have the same sales as the product being replaced. The walker value can be adjusted based on whether the retailer would lose other business the customer would have done at the retailer but for the item not being available.

A retailer uses a walker report to make decisions whether to drop an item from its inventory. For example, the retailer uses walker grid 200 to decide which of two items to drop from the inventory when they both have the same sales rates or profit. In some examples, walker grid 200 contains dots for almost the same product but with some difference (for example, package size). In some examples, these similar items are flagged in the walker report.

In some examples, the accuracy of the techniques described herein is verified using a model predicting lost customers if an item is dropped. To verify the accuracy of the prediction of the walker items, the walker value is multiplied by the model predicting lost customers. In one example, a walker value for an item is verified as shown in equation (2):

$$Walker Value = T * \frac{category spent}{customer} * L \qquad ( 2 )$$

wherein L is a model predicting lost customers. The model predicting lost customers may be based on data gathered from previous drop decisions or other methodologies. In some examples, evaluating the impact estimation of dropping an item is based on having one drop decision per category. In other examples, two or more drop decisions are made in the category.

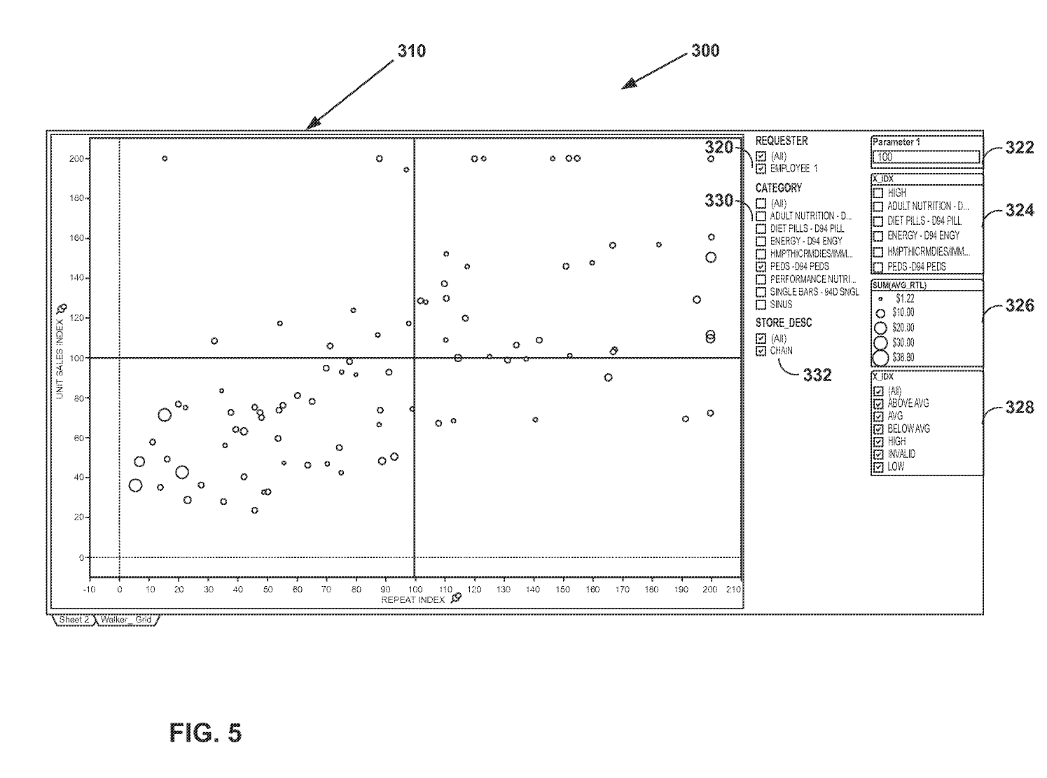

FIG. 5 is a screenshot that illustrates an example graphical user interface (GUI) 300 that outputs a walker grid 310, in accordance with techniques described herein. Walker grid 310 is a graph of unit sales index versus repeat index, similar to walker grid 200 of FIG. 4. Client system 12, server device 20, client devices 30-1 through 30-N, or computing device 102 provide GUI 300, for example. In other examples, other computing devices output GUI 300. FIG. 5 illustrates one potential GUI 300 for outputting walker reports or walker grid 310. In other examples, other formats and information are used.

GUI 300 provides several legends to understand walker grid 310 and filter options for a user, such as user 38-1, to interact with in selecting information to be included in walker grid 310. GUI 300 includes elements 320, 322, 328, and 332 that provide filter options. Element 320 can be used to filter walker grid 310 by who requested the report. Element 322 allows user 38-1 to enter one or more parameters for walker grid 310. The parameter shown in FIG. 5 is an adjustable unit sales index value that sets the y-axis for walker grid 300. The retailer can set the y-axis for the unit sales index to any value desired or appropriate for visualizing the quadrants and detecting the walker items. Additionally, element 328 provides selectable options regarding exclusivity. That is, user 38-1 can interact with element 328 to select what exclusivity ranges (such as high, above average, average, etc.) for the items displayed in walker grid 310.

Element 330 relates to the product category. For example, user 38-1 can select which product categories for display in walker grid 310. Product categories available in the example element 330 include all, adult nutrition, diet pills, energy, homeopathic remedies, peds, performance nutrition, single bars, and sinus. In other examples, other product categories are available. In the example of FIG. 5, the category “peds” is selected. Therefore, walker grid 310 only includes data for items in the category “peds.”

Element 332 provides options for which stores of the retailer to include in the information in walker grid 310. For example, element 332 can provide selections for specific stores of the retailer, all stores, or all stores within a region. In the example of FIG. 5, the options “all” and “chain” are selected in element 332. In other examples, other options are provided or selected.

GUI 310 also displays legends 324 and 326. Legend 324 informs user 38-1 which type of dots displayed in walker grid 310 corresponds to which levels of exclusivity. The dots are differentiated by color, fill, line pattern, or other distinguishable characteristic. Legend 326 informs user 38-1 that the size of the dots corresponds to sales. For example, a larger dot has more sales during a time period of walker grid 310 than a smaller dot.

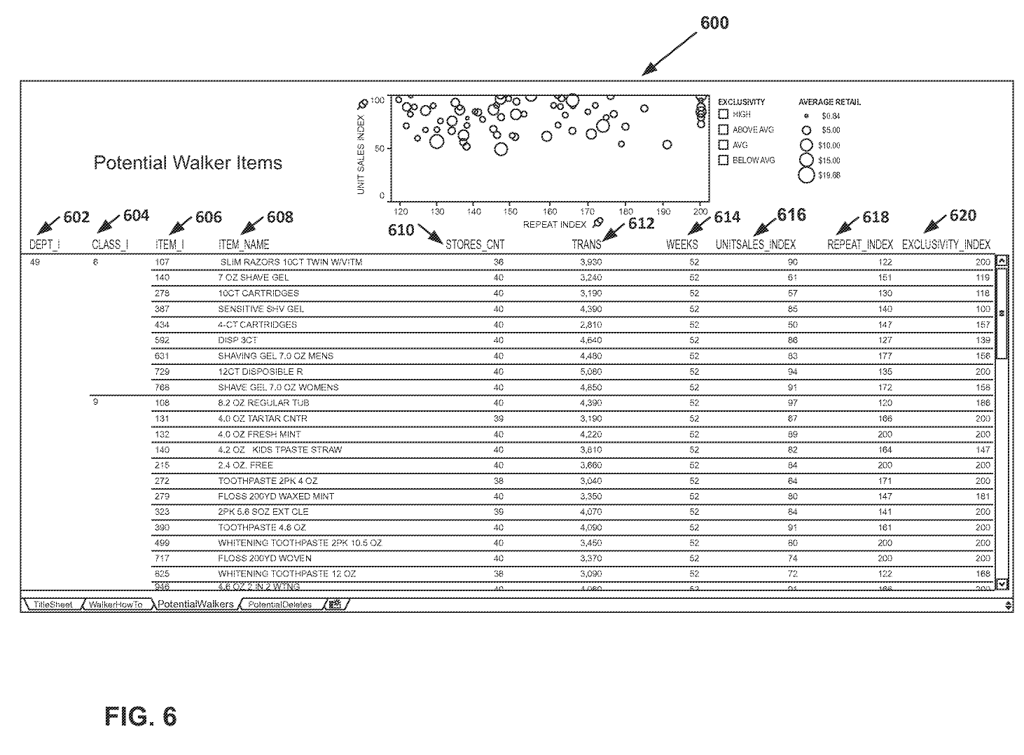

FIG. 6 is a screenshot 600 that lists potential walker items identified in a walker report, in accordance with techniques described herein. The potential walker items are identified according to techniques described herein. Items that have a repeatability value above a determined repeatability threshold (e.g., an adjustable repeat index value), an exclusivity value above a determined exclusivity threshold (e.g., an adjustable exclusivity index value), and a unit sales index value below a unit sales threshold (e.g., an adjustable unit sales index value) are identified as potential walker items.

FIG. 6 uses data and threshold values set from the example of FIG. 5. In this example, the repeat index value is set to 100, the exclusivity index value is set to 100, and the unit sales index value is set to 100. Thus, items having a repeatability value equal to or above 100, an exclusivity index value equal to or above 100, and a unit sales index value equal to or below 100 are included in the potential walker items list. The potential walker items list includes items from quadrant IV of a walker grid.

Identifying information in screenshot 600 include a department of the retailer, DEPT_I 602, a product category of the items, CLASS_I 606, an item number, ITEM_I 606, and an item name, ITEM_NAME 608. The data also includes a number of stores that data was collected from for the corresponding item, STORES_CNT 610, a total number of transactions including a sale of the item, TRANS 612, and a number of weeks that data was collected from, WEEKS 614. Further, values for the unit sales index, UNITSALES_INDEX 616, the repeatability index value, REPEAT_INDEX 618, and the exclusivity index value, EXCLUSIVITY_INDEX 620, are listed in the potential walker items screenshot 600 for each item.

Screenshot 600 assists the retailer or other viewer of the walker report in easily determining which items may potentially be walker items. As shown, the potential walker items list is organized by department within the retailer and further by the product category within the department. The example of FIG. 6 illustrates a department number 49, corresponding to a “health & beauty” department. Walker items in two product categories are shown, hair removal and oral care. In other example walker reports, different information or data is presented. The appearance or presentation of the data within the walker report also differ from that shown in the examples given here.

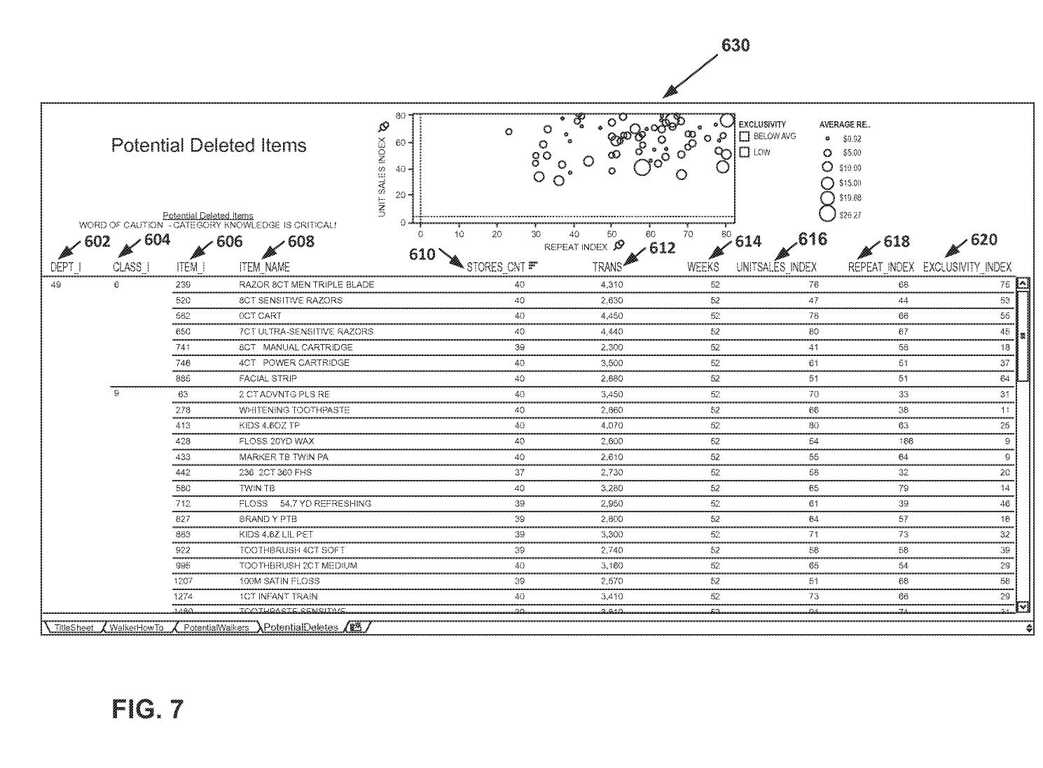

FIG. 7 is a screenshot that lists potential drop items identified in a walker report, in accordance with techniques described herein. FIG. 7 uses data and threshold values set from the example of FIG. 5. In this example, the repeat index value is set to 100, the exclusivity index value is set to 100, and the unit sales index value is set to 100. Thus, items having a repeatability value equal to or below 100, an exclusivity index value equal to or below 100, and a unit sales index value equal to or below 100 are included in the potential drop items list. In another example, items that have a unit sales index value of less than 80 and a repeat index value of less than 80 are included as potential drop items.

The potential drop items list includes items from quadrant III of a walker grid. These items do not make many sales, have low customer repeatability, and have low exclusivity. Therefore, dropping these items does not result in large profit loss for the retailer. In other example walker reports, different information or data is presented. The appearance or presentation of the data within the walker report also differs from that shown in the examples given here.

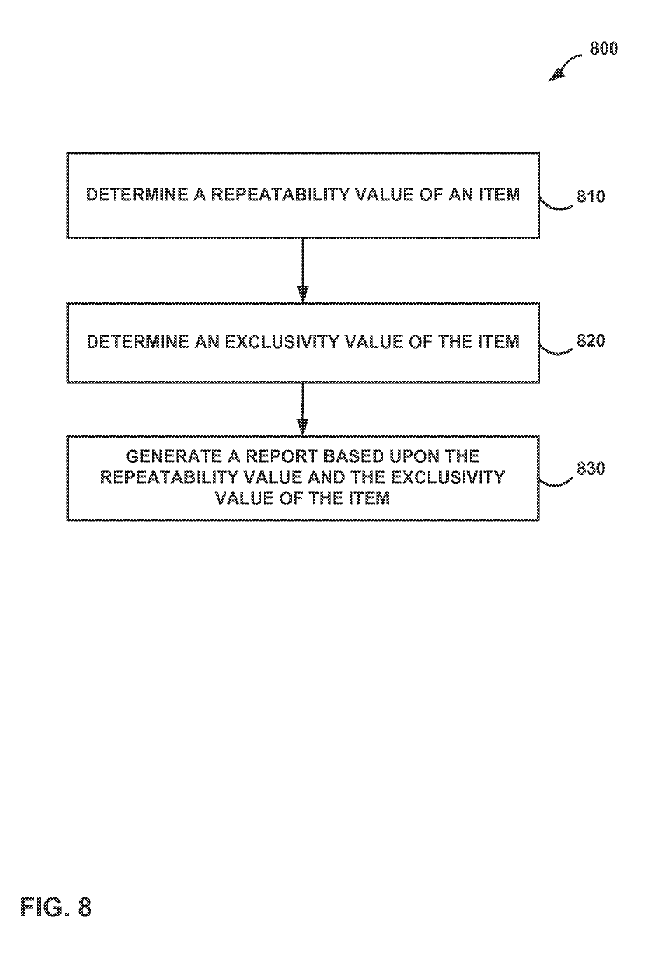

FIG. 8 is a flowchart that illustrates an example method 800 for generating a walker report, in accordance with techniques described herein. Inventory management system 10 of FIGS. 1 and 2 could generate the walker report. FIG. 8 illustrates only one particular example of a method for generating a walker report, and many other examples are used in other instances.

Method 800 further includes determining, by a computing device, a repeatability value of an item in a product category in an inventory at a retailer, wherein the repeatability value indicates how frequently a customer purchases the item out of a plurality of items in the product category (810). In some examples, method 800 includes determining, by the computing device, the product category of the item. For example, retailer 40 uses server device 20 to determine a product category for an item in inventory at a store location of retailer 40. The item is, for example, 12 oz size of organic deodorant in the product category “deodorant.”

Method 800 also includes determining, by the computing device, an exclusivity value of the item, wherein the exclusivity value indicates how frequently the customer purchases the item instead of an alternative item out of the plurality of items in the product category (820). In some examples, determining the exclusivity value of the item further comprises determining that the customer purchased the alternative item in the product category.

Additionally, method 800 includes generating a report related to the inventory of the retailer that is at least partially based upon the repeatability value and the exclusivity value of the item (830). The report is a walker report. The walker report provides information regarding exclusivity, repeatability, sales, and the like for the item. In some examples, the walker report contains information regarding two or more items in the product category. Method 800 further includes defining the inventory based at least in part on the walker report in some examples. In other examples, the report is further based on the exclusivity value and the repeatability value for the item from two or more inventories within a geographical region.

For example, method 800 further includes comparing the exclusivity value to an exclusivity threshold and comparing the repeatability value to a repeatability threshold. Generating the report further comprise recommending keeping the item in the inventory when at least one of the exclusivity value is at or above the exclusivity threshold or the repeatability value is at or above the repeatability threshold, in one example.

Method 800 can further include determining, by the computing device, a sales rate of the item, wherein the sales rate indicates how frequently the item is purchased. In some examples, the prediction is further based on the sales rate of the item. Method 800 further comprises determining an index value for the item, wherein the index value comprises a number of total customers that have purchased the item multiplied by a ratio of a total number of sales in the product category over a time period and a total number of sales of the item over the same time period, further multiplied by a model value predicting lost customers. In some examples, a frequency of purchase of the item based on at least one of size of the item, volume of the item, amount of the item, and seasonality of the item is determined. The index value is adjusted in some examples based on the frequency of purchase of the item.

In some examples, method 800 is performed for more than one item in the product category. In such an example, different items in the category can be compared and contrasted to aid retailer 40 in making decisions about what items to continue to stock. Method 800 includes determining, by the computing device, additional repeatability values of the item and additional exclusivity values of the item for a subset of customers from a set of customers of the retailer, wherein the report is further based upon the additional repeatability values and the additional exclusivity values of the item.

In other examples, method 800 further comprises calculating a prediction of lost customers if the item is removed from the inventory based at least in part on the repeatability value and the exclusivity value. Retailer 40 uses the prediction in deciding whether to continue to stock an item. The report is further based on the prediction of lost customers. In some examples, the report provides a recommendation to keep the item in the inventory based on the prediction of lost customers.

In some examples, the report identifies a loyalty value of the item based on the exclusivity value and the repeatability value. Defining the inventory further includes retaining the item in the inventory when the loyalty value is at or above a walker threshold and removing the item from the inventory when the loyalty value is below the walker threshold. Method 800 further includes scoring the item with respect to all items in the product category for a subset of customers from the customers that purchase the item at the retailer.

Thus, method 800 implements inventory management system 10 to provide information to retailer 40 to use in defining an inventory. Inventory management system 10 identifies merchandise items that have low sales but high loyalty and provides a walker report 310 to one or more users 38 of retailer 40. Through determining repeatability values and exclusivity values for a merchandise item, inventory management system 10 predicts how likely an item is to be a walker item. Based on this information, retailer 40 decides whether to continue stocking the item in its inventory. Knowing which items are likely to be walker items enables the retailer to define its inventory to try to maintain or improve sales.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various examples have been described. These examples and others are within the scope of the following claims.

1. A method, comprising:
determining, by the computing device, a repeatability value of an item in a product category in an inventory at a retailer, wherein the repeatability value indicates how frequently a customer purchases the item out of a plurality of items in the product category;
determining, by the computing device, an exclusivity value of the item, wherein the exclusivity value indicates how frequently the customer purchases the item instead of an alternative item out of the plurality of items in the product category; and
generating a report related to the inventory of the retailer that is at least partially based upon the repeatability value and the exclusivity value of the item.

2. The method of claim 1, further comprising:
determining, by the computing device, the product category of the item.

3. The method of claim 1, further comprising:
calculating a prediction of lost customers if the item is removed from the inventory based at least in part on the repeatability value and the exclusivity value, wherein the report is further based on the prediction of lost customers.

4. The method of claim 3, wherein the report provides a recommendation to keep the item in the inventory based on the prediction of lost customers, the method further comprising:
defining the inventory at the retailer based at least in part on the report.

5. The method of claim 1, further comprising:
comparing the exclusivity value to an exclusivity threshold; and
comparing the repeatability value to a repeatability threshold,
wherein generating the report further comprises recommending keeping the item in the inventory when at least one of the exclusivity value is at or above the exclusivity threshold or the repeatability value is at or above the repeatability threshold.

6. The method of claim 1, wherein determining the exclusivity value of the item further comprises determining that the customer purchased the alternative item in the product category.

7. The method of claim 1, further comprising:
determining, by the computing device, additional repeatability values of the item and additional exclusivity values of the item for additional customers of the retailer, wherein the report is further based upon the additional repeatability values and the additional exclusivity values of the item.

8. The method of claim 1, further comprising:
determining, by the computing device, a sales rate of the item, wherein the sales rate indicates how frequently the item is purchased by all customers of the retailer.

9. The method of claim 8, wherein the prediction is further based on the sales rate of the item.

10. The method of claim 8, further comprising:
determining an index value for the item, wherein the index value comprises a number of total customers that have purchased the item multiplied by a ratio of a total number of sales of all items in the product category over a time period and a total number of sales of the item over the same time period.

11. The method of claim 10, further comprising:
determining a frequency of purchase of the item for all customers of the retailer based on at least one of size of the item, volume of the item, amount of the item, and seasonality of the item; and
adjusting the index value based on the frequency of purchase of the item.

12. The method of claim 1, wherein the report identifies a loyalty value of the item based on the exclusivity value and the repeatability value, and wherein defining the inventory further comprises:
retaining the item in the inventory when the loyalty value is at or above a walker threshold; and
removing the item from the inventory when the loyalty value is below the walker threshold.

13. The method of claim 1, further comprising:
scoring the item with respect to all items in the product category for a subset of customers from the customers that purchase the item at the retailer.

14. The method of claim 1, wherein the report is based on the exclusivity value and the repeatability value for the item from two or more inventories at two or more retailer locations within a geographical region.

15. A computer system that comprises:
one or more computer-readable storage media; and
one or more processors coupled to the one or more computer-readable storage media, execution by the one or more processors of instructions stored on the one or more computer-readable storage media causing the computer system to:
determine how frequently a customer purchases an item out of a plurality of items in a product category to which the item belongs;
determine how frequently the customer purchases the item instead of an alternative item out of the plurality of items in the product category;
calculating a prediction of lost customers if the item is removed from the inventory based at least in part on the determination of how frequently the customer purchases the item out of a plurality of items in the product category and the determination of how frequently the customer purchases the item instead of the alternative item out of the plurality of items in the product category; and
generate a report based upon the prediction of lost customers.

16. The computer system of claim 15, wherein instructions stored on the one or more computer-readable storage media further cause the computer system to:
determine an index value for the item, wherein the index value is at least partially based on a number of total customers that have purchased the item, a total number of sales in the product category over a time period, and a total number of sales of the item over the time period.

17. The computer system of claim 16, wherein the report identifies a loyalty value of the item based at least in part on the determination of how frequently the customer purchases the item out of the plurality of items in the product category and the determination of how frequently the customer purchases the item instead of the alternative item, and wherein instructions stored on the one or more computer-readable storage media further cause the computer system to:
determine a frequency of purchase of the item based on at least one of size of the item, volume of the item, amount of the item, and seasonality of the item;
adjust the index value based on the frequency of purchase of the item and the loyalty value;
compare the index value to a walker threshold;
retain the item in the inventory when the index value is at or above the walker threshold; and
remove the item from the inventory when the index value is below the walker threshold.

18. A computer program product that comprises one or more computer-readable storage media that store instructions that, when executed by one or more processors, cause a computer system to:
determine how frequently a customer of a retailer purchases an item in a product category out of a plurality of items in the product category, wherein the item is in an inventory at a retailer;
determine how frequently the customer purchases the item instead of an alternative item in the product category;
determine a loyalty value of the item based at least in part on the determination of how frequently the customer purchases the item out of the plurality of items in the product category and the determination of how frequently the customer purchases the item instead of the alternative item; and
define the inventory at the retailer at least partially based upon the loyalty value.

19. The computer program product of claim 18, wherein instructions stored on the one or more computer-readable storage media further cause the computer system to:
generate a report predicting a potential for reduced sales if the item is removed from the inventory based at least in part on the loyalty value.

20. The computer program product of claim 18, wherein instructions stored on the one or more computer-readable storage media further cause the computer system to:
determine an index value for the item, wherein the index value is at least partially based on a number of total customers that have purchased the item, a total number of sales in the product category over a time period, and a total number of sales of the item over the time period, wherein the inventory is further defined by the index value.
